(19) United States
(12) Patent Application Publication
(10) Pub. No.: US 2013/0215206 A1
(43) Pub. Date: Aug. 22, 2013

(54) PRINTER

(71) Applicant: Seiko Epson Corporation, (US)

(72) Inventor: Kunihiko Matsuhashi, Matsumoto-shi (JP)

(73) Assignee: Seiko Epson Corporation, Tokyo (JP)

(21) Appl. No.: 13/772,974

(22) Filed: Feb. 21, 2013

(30) Foreign Application Priority Data
Feb. 21, 2012 (JP) 2012-034863

(51) Int. Cl. B41J 3/407

(52) U.S. Cl. CPC B41J 3/407
USPC 347/105

(57) ABSTRACT

A printer includes a print head in which a plurality of nozzles, which discharges ink, are formed, a platen which supports the medium below the plurality of nozzles, a feeding mechanism which feeds the medium between the print head and the platen, a pair of drawing-out rollers which is provided further forward in a transport direction of the medium than the print head, pinches the medium, and draws out the medium between the print head and the platen, and a drawing-out guide which is provided between the platen and the pair of drawing-out rollers, supports the medium, and guides the medium up to the pair of drawing-out rollers, wherein a distance between a virtual plane on which the plurality of nozzles are arranged and the drawing-out guide is larger than a distance between the virtual plane and the platen when ink is discharged from the nozzle to the medium.

### BACKGROUND

1. Technical Field

The present invention relates to a printer.

2. Related Art

In the related art, when a bag is manufactured by performing thermo-compression bonding to three sides of a plastic film, it is known that the bag is bent or undulated due to heat shrinkage. When ink is sprayed to the surface of the medium which is not flat and an image is formed, since a distance between a nozzle which discharges the ink and the medium is not constant, there is a problem in that image quality is deteriorated. In JP-A-11-91292, a technology is disclosed in which a medium is sucked to a platen and thus, the distance between a nozzle and the medium becomes constant.

However, there is a problem in that the suction mechanism of the platen disclosed in JP-A-11-91292 causes an increase of a size of a printer or an increase of power consumption.

### SUMMARY

An advantage of some aspects of the invention is to form an image having high quality on a medium which is not flat.

(1) According to an aspect of the invention, there is provided a printer including: a print head in which a plurality of nozzles, which discharges ink toward a medium, are formed; a platen which supports the medium immediately below the plurality of nozzles; a feeding mechanism which feeds the medium between the print head and the platen; a pair of drawing-out rollers which is provided further forward in a transport direction of the medium than the print head, pinches the medium, and draws out the medium between the print head and the platen; and a drawing-out guide which is provided between the platen and the pair of drawing-out rollers, supports the medium, and guides the medium up to the pair of drawing-out rollers, wherein a distance between a virtual plane on which the plurality of nozzles are arranged and the drawing-out guide is larger than a distance between the virtual plane and the platen when ink is discharged from the nozzle to the medium.

Here, it is described how a shape of a medium M is maintained when the medium M which is not flat as shown in FIGS. 1B and 1C is supported by platens 5x and 5y. Moreover, FIGS. 1B and 1C show that the medium M is curved along a curve which does not have singular points. However, in fact, the medium is slightly undulated irregularly. Compared to a case where the medium M which is not flat is supported by the platen 5x in which the top surface is flat as shown in FIG. 1B, in a case where the entire concave surface of the medium M is supported by the platen 5y which has a convex surface substantially corresponding to the concave surface as shown in FIG. 1C as the top surface, a height difference Δh of the medium M is decreased. Moreover, when it is considered so as to include the height difference between the medium M and the top surface of the platen, in the case where the entire concave surface of the medium M is supported by the convex surface substantially corresponding to the concave surface, a height difference ΔH is further decreased. According to the aspect of the invention, since the drawing-out guide is positioned further away than the platen when viewed from the virtual plane on which the nozzles are arranged, the concave surface of the medium which is curved so as to be convex to the print head side as a whole can be supported at the position corresponding to the concave surface of the medium. Thereby, according to the aspect of the invention, the height difference of the medium which is bent immediately below the nozzles is suppressed, deviation of the distance from the platen to the medium can be suppressed, and as a result, the distance from the nozzles to the medium can be equalized. Therefore, according to the aspect of the invention, an image having high quality can be formed on the medium which is not flat.

(2) In the printer, the printer may further include a lifting and lowering mechanism which adjusts the distance between the virtual plane and the drawing-out guide by moving the drawing-out guide in a direction perpendicular to the virtual plane.

By adopting this configuration, since the height of the drawing-out guide is changed according to the shape of the medium, the height difference of the medium can be further suppressed.

(3) In the printer, the printer may further include an actuator which causes the platen be away from the virtual plane when a tip of the medium approaches the platen from the feeding mechanism and causes the platen be close to the virtual plane when the medium moves on the platen.

Since the convex surface becomes the concave surface if an external force is applied to the medium which is not flat in a state where the external force is not applied, the shape is not easily returned to the original shape even after the external force is removed. Accordingly, it is preferable that the medium fed by the feeding medium does not contact the platen if possible until a predetermined region of the medium is supported by the platen and the drawing-out guide. When the tip of the medium approaches the platen from the feeding mechanism, the platen is lowered, and thus, it is possible to prevent the medium from being deformed to an unexpected shape, that is, a shape which is not the shape in which the height difference can be suppressed by supporting of the platen and the drawing-out guide.

(4) In the printer, the printer may further include a rotating shaft movement mechanism which moves a rotating shaft of at least one roller of the pair of drawing-out rollers in a direction perpendicular to the virtual plane.

By adopting this configuration, since the medium can be drawn out between the print head and the platen while preventing the middle of the medium on which ink is landed from being deformed due to the drawing-out rollers, image quality can be further improved.

(5) In the printer, the platen may support the medium immediately below the nozzle which is positioned at least most forward in the transport direction of the medium of the plurality of nozzles.

### BRIEF DESCRIPTION OF THE DRAWINGS

The invention will be described with reference to the accompanying drawings, wherein like numbers reference like elements.

FIG. 1A is a schematic view showing an embodiment of the invention.

FIGS. 1B and 1C are perspective views showing the embodiment of the invention.

FIG. 2 is a schematic view showing the embodiment of the invention.

FIG. 3 is a schematic view showing the embodiment of the invention.

FIG. 4 is a schematic view showing the embodiment of the invention.

FIGS. 5A and 5B are schematic views showing an embodiment of the invention.

### DESCRIPTION OF EXEMPLARY EMBODIMENTS

Hereinafter, an embodiment of the invention will be described according to the following order with reference to the accompanying drawings. Moreover, the same reference numerals are attached to the corresponding components in each drawing, and the overlapped descriptions are omitted.

### 1. Overall Outline

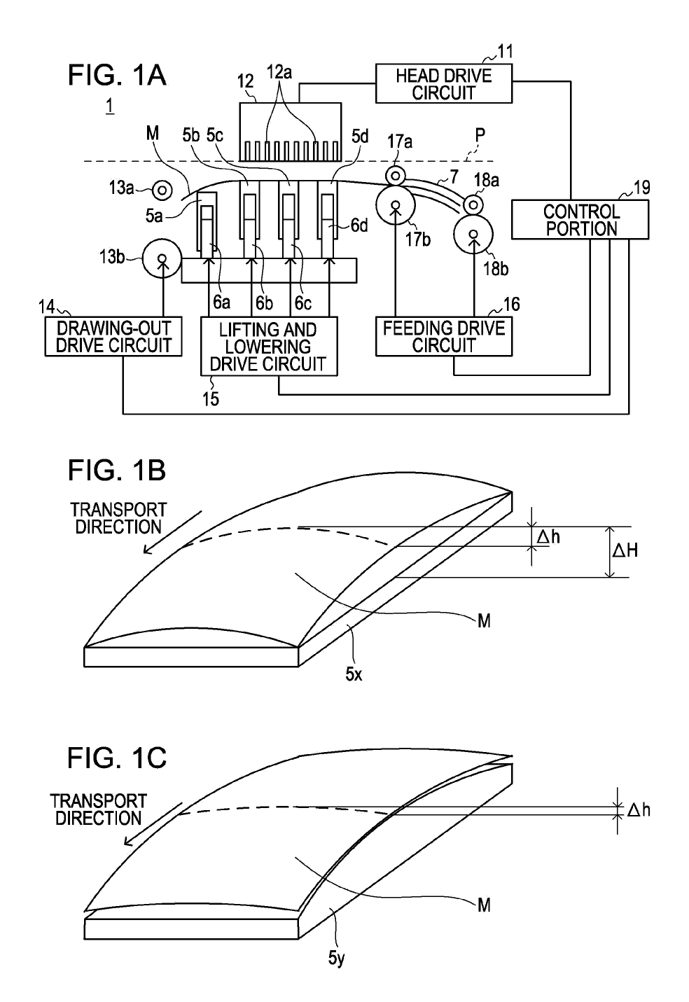

FIG. 1A shows a printer 1 which is an example of the invention. The printer 1 is a serial type ink jet printer in which a bag, in which thermo-compression bonding is performed to three sides and which is configured by a plastic film, is a medium M, and an image is formed on the medium M. The printer 1 includes: a print head 12 in which a plurality of nozzles 12a which discharge ink toward the medium M are formed; platens 5b, 5c, and 5d which support the medium M immediately below the plurality of nozzles 12a; a feeding mechanism which feeds the medium M between the print head 12 and the platens 5b, 5c, and 5d; a pair of drawing-out rollers 13a and 13b which is provided further forward in a transport direction of the medium M than the print head 12, pinches the medium M, and draws out the medium M between the print head 12 and the platens 5b, 5c, and 5d; and a drawing-out guide 5a which guides the medium M up to the pair of drawing-out rollers 13a and 13b. The medium M in which thermo-compression bonding is performed to three sides is bent as a whole and easily undulated locally. Since the printer 1 includes a mechanism which flatly maintains the medium M immediately below the print head 12, a high-definition image can be formed on the medium M.

### 2. Configuration of Printer

The print head 12 discharges ink which is supplied from a tank (not shown) from the plurality of nozzles 12a using an actuator such as a piezoelectric element (not shown). The plurality of nozzles 12a are arranged in two dimensions on a virtual plane P. The actuator for discharging the ink from the nozzles is provided for each nozzle 12a and is driven by a head drive circuit 11. Moreover, the print head 12 is supported so as to move in a main scanning direction corresponding to a direction perpendicular to a paper surface of FIG. 1A, and is pulled in the main scanning direction by a pulling mechanism (not shown).

Guides 6b, 6c, and 6d are inserted into recesses of the platens 5b, 5c, and 5d. Thereby, the platen 5b, 5c, and 5d are supported so as to slide in a direction perpendicular to the virtual plane P on which the nozzles 12a are arranged. The platen 5b, 5c, and 5d include top surfaces which are longer in the main scanning direction than the width (length in the main scanning direction) of the medium M and are parallel to the virtual plane P. The platens 5b, 5c, and 5d are arranged in the above order from forward in the transport direction of the medium M to backward in the transport direction. That is, the platen 5b supports the medium M immediately below the nozzle which is positioned most forward in the transport direction of the medium M of the plurality of nozzles 12a. The platen 5d supports the medium M immediately below the nozzle which is positioned most backward in the transport direction of the medium M of the plurality of nozzles 12a. The platen 5c supports the medium M between the platens 5b and 5d.

The drawing-out guide 5a is provided between the platens 5b, 5c, and 5d and the drawing-out rollers 13a and 13b, and similar to the platen 5b, 5c, and 5d, is supported so as to slide in a guide 6a. That is, the drawing-out guide 5a and the guide 6a moves the drawing-out guide 5a in the direction perpendicular to the virtual plane P and thus, configures a lifting and lowering mechanism which adjusts a distance from the virtual plane P to the drawing-out guide 5a.

The guides 6a, 6b, 6c, and 6d include a coil (not shown) which lowers the drawing-out guides 5a and the platens 5b, 5c, and 5d if voltage is applied by a lifting and lowering drive circuit 15. Moreover, springs (not shown) are provided between the guides 6a, 6b, 6c, and 6d, and the drawing-out guides 5a and platens 5b, 5c, and 5d, and push up the drawing-out guides 5a and the platens 5b, 5c, and 5d toward the virtual plane P. That is, the guides 6a, 6b, 6c, and 6d function as a linear actuator which moves the drawing-out guides 5a and the platens 5b, 5c, and 5d to the direction perpendicular to the virtual plane P.

The feeding mechanism, which feeds the medium M between the print head 12 and the platens 5b, 5c, and 5d, includes feeding rollers 17a and 17b, relay rollers 18a and 18b, a feeding guide 7, and the like. The feeding rollers 17a and 17b and the relay rollers 18a and 18b include outer circumferential surfaces which contact only both-side edge portions in the main scanning direction which are a non-printing area of the medium M. That is, the feeding rollers 17a and 17b and the relay rollers 18a and 18b do not contact a printing area of the medium M. In the feeding rollers 17a and 17b and the relay rollers 18a and 18b, the respective rotating shafts are supported so as to have posture parallel to the main scanning direction, the rotating shafts are driven by a feeding drive circuit 16 including an electric motor (not shown), and thus, feeding rollers 17a and 17b and the relay rollers 18a and 18b are rotated. The feeding guide 7 is provided between the relay rollers 18a and 18b and the feeding rollers 17a and 17b, and guides the medium M fed by the relay rollers 18a and 18b to a position in which the medium is interposed between the feeding rollers 17a and 17b. Moreover, the feeding guide 7 forms a narrow transport passage in order to deform the medium M so as to curve the medium M to be convex to the virtual plane P side as a whole when the feeding rollers 17a and 17b feed the medium M. That is, the medium M fed by the relay rollers 18a and 18b is curved along the feeding guide 7, and thus, has a shape which is curved to be convex to the virtual plane P side as a whole when the medium is fed onto the platens 5b, 5c, and 5d by the feeding rollers 17a and 17b.

The drawing-out rollers 13a and 13b include outer circumferential surfaces which contact only both-side edge portions in the main scanning direction which are non-printing areas of the medium M. That is, the drawing-out rollers 13a and 13b do not contact a printing area of the medium M. In the drawing rollers 13a and 13b, the respective rotating shafts are supported so as to have posture parallel to the main scanning direction, the rotating shafts are driven by a drawing-out drive circuit 14 including an electric motor (not shown), and thus, the drawing-out rollers 13a and 13b are rotated. The rotating shaft of the drawing-out roller 13b, which is provided further away than the drawing-out roller 13a from the virtual plane P, is supported so as to move to the direction perpendicular to the virtual plane P, and is pushed down by a spring (not shown). The drawing-out drive circuit 14 includes a coil which generates a magnetic force which pushes up the rotating shaft of the drawing-out roller 13b in the direction perpendicular to the virtual plane P. That is, the drawing-out drive circuit 14 functions as a rotating shaft movement mechanism which moves the rotating shaft of the drawing-out roller 13b in the direction perpendicular to the virtual plane P.

The control portion 19 is a computer which includes a ROM, a RAM, a CPU, or the like, controls the head drive circuit 11, the feeding drive circuit 16, the lifting and lowering drive circuit 15, the drawing-out drive circuit 14, and the like by performing print control programs stored in the ROM, and operates the printer 1 as described below.

### 3. Operation of Printer

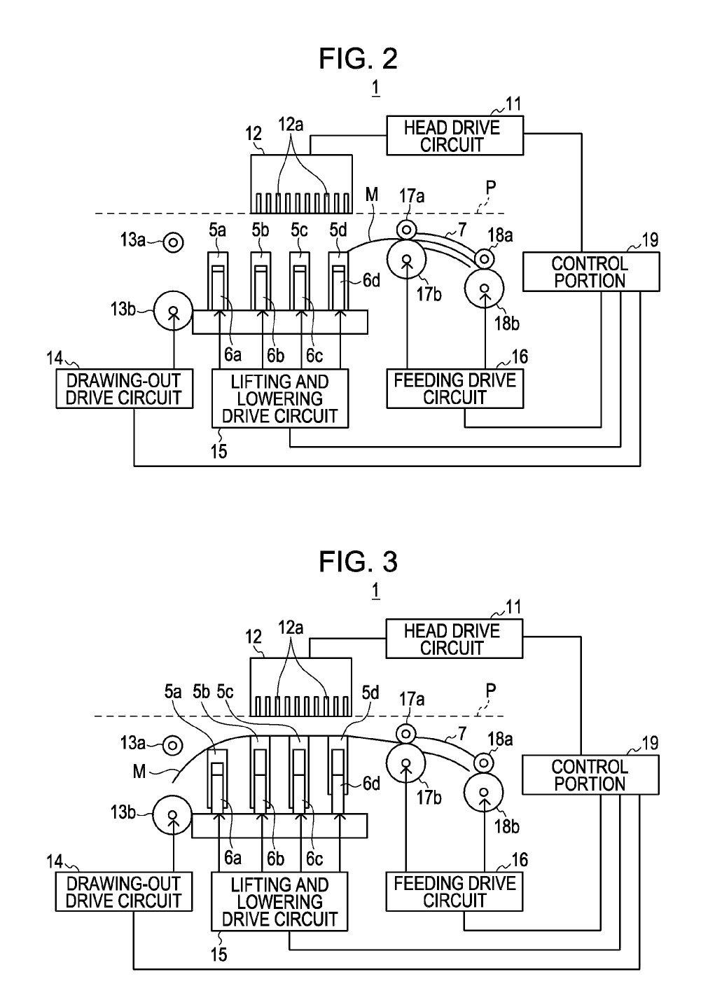

First, the relay rollers 18a and 18b feed the medium M, which is taken out from a tray (not shown), to the narrow transport passage which is formed by the feeding guide 7. As shown in FIG. 2, the medium M, which is arranged in the shape curved so as to be convex to the print head 12 by the feeding guide 7, is interposed between the feeding rollers 17a and 17b.

At this time, the platens 5b, 5c, and 5d and the drawing-out guide 5a are lowered by the guides 6a, 6b, 6c, and 6d, and is positioned further away than a point of contact of the feeding roller 17a and 17b when viewed from the virtual plane P. Moreover, at this time, top surfaces of the platens 5b, 5c, 5d and the drawing-out guide 5a are positioned at the same plane parallel to the virtual plane P. When the tip of the medium Mapproaches the platens 5b, 5c, and 5d from the feeding rollers 17a and 17b, the platens 5b, 5c, and 5d are lowered, the platens 5b, 5c, and 5d are further away from the virtual plane P than the contact point of the feeding rollers 17a and 17b, and thus, the medium M is prevented from contacting the platens 5b, 5c, and 5d and being deformed. Therefore, as shown in FIG. 2, the medium M reaches on the platens 5b, 5c, and 5d in a state where the curved shape which is formed by the feeding guide 7 is maintained.

If the medium M reaches on the platens 5b, 5c, and 5d, as shown in FIG. 1A, the platens 5b, 5c, and 5d are pushed up along the guides 6b, 6c, and 6d by a spring (not shown), and the medium moves so as to be closer to the virtual plane P than the point of contact of the feeding rollers 17a and 17b when viewed from the virtual plane P. The heights of the guides 6b, 6c, and 6d are set so that the distance from the virtual plane P on which the nozzles 12a are arranged to the medium M is a predetermined value. Here, when the platens 5b, 5c, and 5d are pushed up, the distance from the platens 5b, 5c, and 5d to the virtual plane P may be set to be constant, and the distance from the concave surface below the medium M to the virtual plane P may be set so as to be constant, and in this case, a slight height difference may be generated. In addition, it is preferable that the heights of the platens 5b, 5c, and 5d and the drawing-out guide 5a be set so that the medium M is smoothly bent due to its own weight in the platen 5b which is positioned immediately below the nozzle positioned at the most downstream in the transport direction.

Moreover, at this time, as shown in FIG. 1A, the drawings-out guide 5a is pushed up to the full extent of the height, which can support the medium without deforming the shape of the medium M supported by the platens 5b, 5c, and 5d, by a spring (not shown), and the height of the drawing-out guide is maintained by the magnetic force of the guide 6a.

Moreover, since the medium M is formed so as to be convex to the virtual plane P side as a whole by the feeding guide 7, the drawing-out guide 5a is maintained to the height lower than that of the platen 5b. Moreover, the height difference between the drawing-out guide 5a and the platens 5b, 5c, and 5d is adjusted according to the medium M. Specifically, the height difference between the drawing-out guide 5a and the platens 5b, 5c, and 5d is adjusted so as to be larger, as the entire curvature radius of the medium M is smaller in the sub scanning direction, and the height difference is adjusted so as to be smaller, as the entire curvature radius of the medium M is larger in the sub scanning direction.

In this way, if the medium M becomes the state in which the medium is supported by the drawing-out guide 5a, and the platens 5b, 5c, and 5d positioned higher than the drawing-out guide 5a, the height difference of the medium M immediately below the nozzles 12a is suppressed, and deviation in the main scanning direction of the distance from the nozzles 12a to the medium M is suppressed. The formation of the image with respect to the medium M is performed in the above-described state.

That is, as shown in FIGS. 1A and 3, in the state where the medium M is supported by the platens 5b, 5c, and 5d and the drawing-out guide 5a, ink is discharged from the nozzles 12a of the print head 12 toward the medium M, and the image is formed by the ink which is landed on the medium M. In addition, for example, it is preferable that the deviation of the distance from the nozzles 12a to the medium M be ±0.2 mm in the main scanning direction and ±0.1 mm in the medium transport direction (sub scanning direction). If the deviation is the error of the above-described extent, a sharp image free from blurs can be formed on the medium M. In addition, since the medium M is supported by the platens 5b, 5c, and 5d and the drawing-out guide 5a having heights different from each other, the deviation of the distance from the nozzles 12a to the medium M can be suppressed so as to be less than or equal to ±0.2 mm in the main scanning direction. Moreover, the direction in which the height difference of the medium M immediately below the nozzles 12a is suppressed is mainly the main scanning direction.

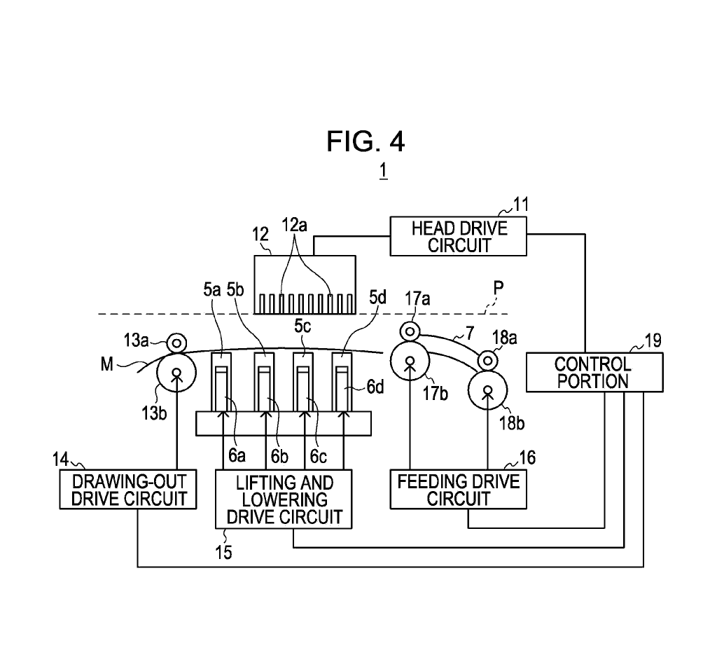

As shown in FIG. 3, if the medium M is positioned at the position in which the medium can be interposed by the drawing-out rollers 13a and 13b and the discharging of the ink to the medium M ends, the rotating shaft of the drawing-out roller 13b is pushed up toward the virtual plane P and the medium M is interposed between the drawing-out rollers 13a and 13b as shown in FIG. 4. Moreover, the drawing-out rollers 13a and 13b are rotated, and thus, the medium M is drawn out between the print head 12 and the platens 5b, 5c, and 5d. At this time, the platens 5b, 5c, and 5d and the drawing-out guide 5a are further away from the virtual plane P than the contact point of the feeding rollers 17a and 17b, and thus, the contact between the next medium fed by the feeding rollers 17a and 17b, and the platens 5b, 5c, and 5d and the drawing-out guide 5a is prevented.

According to the embodiment described above, the height difference of the medium M which is bent immediately below the nozzles 12a is suppressed, the deviation of the distance from the platens 5b, 5c, and 5d to the medium M can be suppressed, and as a result, the distance from the nozzles 12a to the medium M can be equalized. Thereby, an image having high quality can be formed on the medium M which is not flat. Moreover, since the height of the drawing-out guide 5a is changed according to the shape of the medium M, the height difference of the medium M can be further suppressed. In addition, when the tip of the medium M approaches the platens 5b, 5c, and 5d from the feeding mechanism, the platens 5b, 5c, and 5d are lowered, and thus, it is possible to prevent the medium M from being deformed to an unexpected shape, that is, a shape which is not the shape in which the height difference can be suppressed by supporting of the platens 5b, 5c, and 5d and the drawing-out guide 5a. Moreover, it is possible to prevent the medium M from being deformed because an external force is applied to the middle of the medium M on which ink is landed by the drawing-out rollers 13a and 13b, and image quality can be further improved.

### 4. Other Embodiments

In addition, a technical range of the aspect of the invention is not limited to the above-described embodiment, and it is needless to say that various modifications can be applied within a scope which does not depart from the gist of the invention.

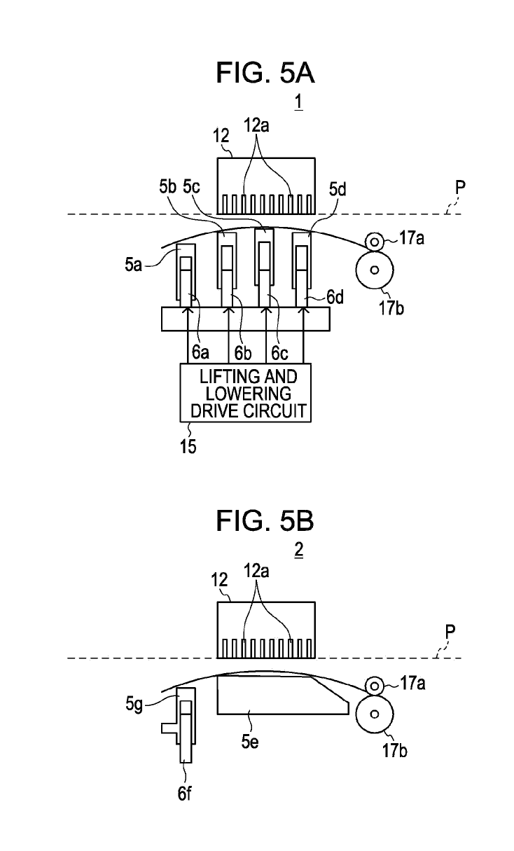

For example, as shown in FIG. 5A, the heights, which are maintained by pushing up the platens 5b, 5c, and 5d immediately below the nozzles 12a during the formation of the image, may be different according to the shape of the medium, and may be arranged on the plane parallel to the virtual plane P. When the heights of the platens 5b, 5c, and 5d are arranged regardless of the shape of the medium M, the lifting and lowering mechanisms of the platens 5b, 5c, and 5d may be used in common, and as a printer 2 shown in FIG. 5B, the medium M may be supported immediately below the nozzles by one platen 5e. That is, the number of the platens which supports the medium immediately below the nozzles may be one or more, and may be two or four or more. Moreover, the height of the platen 5e shown in FIG. 5B may be fixed without being controlled according to the position in the sub scanning direction of the medium M.

In addition, an electric motor, a piezoelectric element, or the like can be used for the actuator which moves the platens 5b, 5c, and 5d and the drawing-out guides 5a in the direction perpendicular to the virtual plane P.

Moreover, in addition to a slider, a lever or a cam can be used for a mechanism which links the actuator, the platens 5b, 5c, and 5d, and the drawing-out guide 5a.

In addition, the gap between the platens 5b, 5c, and 5d and the drawing-out guide 5a may be separated to each other as shown in FIGS. 1A, and 2 to 5A, and may approach to the extent in which the platens and the drawing-out guide contact each other. When the platens 5b, 5c, and 5d and the drawing-out guide 5a are separated to each other as shown in FIGS. 1A, and 2 to 5A, the platens 5b, 5c, and 5d and the drawing-out guide 5a is accommodated in a case in which the top surface is flat and may protrude from grooves formed on the top surface of the case only when the platens 5b, 5c, and 5d and the drawing-out guide 5a are pushed up.

Moreover, as shown in FIG. 5B, a drawing-out guide 5g is supported by a guide 6f which does not have a driving force, and thus, the drawing-out guide 5g may be lifted and lowered manually. That is, even in a printer which does not have the actuator for moving the drawing-out guide and the platen to the direction perpendicular to the virtual plane P on which the nozzles are arranged, the advantages of the invention can be achieved.

In addition, the drawing-out roller 13a close to the virtual plane P of the pair of drawing-out rollers 13a and 13b may be moved to the direction perpendicular to the virtual plane P. Moreover, an electric motor or the like may be used for the actuator for moving the pair of drawing-out rollers 13a and 13b in the direction perpendicular to the virtual plane P, and a cam or a lever may be used for the link.

In addition, the invention may also be applied to a line type ink jet printer, and the kind of the medium is not object. For example, the above-described printer 1 flattens a paper medium in which flatness is lost due to moisture and can improve the image quality of print.

The entire disclosure of Japanese Patent Application No. 2012-34863, filed Feb. 21, 2012 is expressly incorporated by reference herein.

What is claimed is:

1. A printer comprising:
a print head in which a plurality of nozzles, which discharges ink toward a medium, are formed;
a platen which supports the medium immediately below the plurality of nozzles;
a feeding mechanism which feeds the medium between the print head and the platen;
a pair of drawing-out rollers which is provided further forward in a transport direction of the medium than the print head, pinches the medium, and draws out the medium between the print head and the platen; and
a drawing-out guide which is provided between the platen and the pair of drawing-out rollers, supports the medium, and guides the medium up to the pair of drawing-out rollers,
wherein a distance between a virtual plane on which the plurality of nozzles are arranged and the drawing-out guide is larger than a distance between the virtual plane and the platen when ink is discharged from the nozzle to the medium.

2. The printer according to claim 1, further comprising:
a lifting and lowering mechanism which adjusts the distance between the virtual plane and the drawing-out guide by moving the drawing-out guide in a direction perpendicular to the virtual plane.

3. The printer according to claim 1, further comprising:
an actuator which causes the platen to be away from the virtual plane when a tip of the medium approaches the platen from the feeding mechanism and causes the platen to be close to the virtual plane when the medium moves on the platen.

4. The printer according to claim 1, further comprising:
a rotating shaft movement mechanism which moves a rotating shaft of at least one roller of the pair of drawing-out rollers in a direction perpendicular to the virtual plane.

5. The printer according to claim 1,
wherein the platen supports the medium immediately below the nozzle which is positioned at least most forward in the transport direction of the medium of the plurality of nozzles.
